(19) United States
(12) Patent Application Publication
(10) Pub. No.: US 2020/0406847 A1
(43) Pub. Date: Dec. 31, 2020

(54) VEHICLE SAFETY SYSTEMS AND METHODS

(71) Applicant: QUIMPLE LTD., Nehalim (IL)

(72) Inventor: Avraham OHANA, Nehalim (IL)

(21) Appl. No.: 16/976,149

(22) PCT Filed: Feb. 14, 2019
(86) PCT No.: PCT/IB2019/051194

§ 371 Date: Aug. 27, 2020

Related U.S. Application Data
(60) Provisional application No. 62/630,280, filed on Feb. 14, 2018.

(51) Int. Cl. B60R 21/01; B60W 50/12; H04W 4/48; H04W 4/80

(52) U.S. Cl. CPC B60R 21/01; B60W 50/12; B60R 2021/01088; H04W 4/80; H04W 4/48

(57) ABSTRACT

Vehicle safety systems may include a tag reader, a control unit, and an application executable on a mobile communication device. The tag reader attaches to a mounting mechanism deployed within a vehicle, and reads a tag attached to the mobile communication device in response to mounting the mobile communication device to the mounting mechanism. The control unit receives a verification signal from the tag reader in response to reading of the tag by the tag reader, and sends an activation signal to the mobile communication device in response receipt of the verification signal. The application switches operation of the mobile communication device from a first operational mode to a second operational mode by disabling touchscreen operation and enabling voice command operation in response to receipt of the activation signal by the mobile communication device.

### CROSS-REFERENCE TO RELATED APPLICATIONS

This application claims priority from U.S. Provisional Patent Application No. 62/630,280, filed Feb. 14, 2018, whose disclosure is incorporated by reference in its entirety herein.

### TECHNICAL FIELD

The present invention relates to vehicle safety systems and methods.

### BACKGROUND OF THE INVENTION

Studies have shown that the use (i.e., operation) of mobile communication devices (e.g., smartphones) while driving is a leading cause of vehicle accidents. Technological advancements in the development of smartphone software applications has led to a substantial number of smartphone features and software applications, executable on the smartphone, that can contribute to driver distractions. Examples of such features and applications include, but are not limited to, phone services, text messaging services and applications (e.g., WhatsApp), navigation applications (e.g., Waze and Google Maps), email applications, and notification applications (e.g., alarms, reminders, etc.). As a result, drivers are subjected to distractions from smartphones while driving, as a result of, for example, placing outgoing phone calls, answering incoming phone calls, reading incoming text messages, composing and sending outgoing text messages, reading incoming email messages, composing and sending outgoing email messages, activating navigation applications in order to reach a specific location or destination, and receiving notifications related to, for example, incoming phone calls, incoming text messages, reminder services, and the like.

Various mechanisms have been developed in order to reduce potential distraction from smartphones for drivers. Such mechanisms include, for example, hands-free calling kits (typically utilizing Bluetooth® based communication), smartphone mounting mechanisms which allow the driver to mount the smartphone to a stand that is attached to the vehicle dashboard, and voice command interface applications which allow drivers to activate various smartphone features via voice commands.

Notwithstanding the above, and in view of the multitude of features provided by smartphones, there is still a relatively high degree of use of smartphones by drivers while driving.

### SUMMARY OF THE INVENTION

The present invention is directed to vehicle safety systems and methods.

According to the teachings of an embodiment of the present invention, there is provided a safety system for a vehicle. The safety system comprises: a tag reader operatively coupled to a mounting mechanism deployed within a vehicle, the tag reader being operative to read a tag in communication with a mobile communication device in response to mounting the mobile communication device to the mounting mechanism; a control unit configured to: receive a verification signal from the tag reader in response to reading of the tag by the tag reader, and send an activation signal to the mobile communication device in response to receipt of the verification signal; and an application executable on the mobile communication device, the application configured to: switch operation of the mobile communication device from a first operational mode to a second operational mode by disabling touchscreen operation of the mobile communication device and enabling voice command operation of the mobile communication device in response to receipt of the activation signal by the mobile communication device.

Optionally, the control unit is further configured to enable activation of an ignition system of the vehicle in response receipt of the verification signal.

Optionally, the tag is implemented as an electronic tag and the tag reader is implemented as an electronic tag reader.

Optionally, the tag is implemented as a near field communication (NFC) tag.

Optionally, the tag reader is implemented as a near field communication (NFC) reader.

Optionally, the tag is implemented as a barcode and the tag reader is implemented as a bar code reader.

Optionally, the control unit is further configured to: receive a second verification signal from the tag reader in response to removing the mobile communication device from the mounting mechanism, and send a deactivation signal to the mobile communication device in response receipt of the second verification signal.

Optionally, the application is further configured to switch operation of the mobile communication device from the second operational mode to the first operational mode by enabling touchscreen operation of the mobile communication device in response to receipt of the deactivation signal by the mobile communication device.

Optionally, the safety system further comprises: a communication transmission unit operatively coupled to the control unit, and the control unit is configured to send the activation signal to the mobile communication device via transmission of the activation signal by the communication transmission unit.

Optionally, the communication transmission unit is implemented as a wireless communication transmission unit.

Optionally, the communication transmission unit is implemented as a Bluetooth communication transmission unit.

Optionally, the application is further configured to: actuate an image sensor of the mobile communication device to capture an image of the face of an operator of the vehicle in response to receipt of the activation signal by the mobile communication device.

Optionally, the application is further configured to: compare the captured image of the face of the operator to a stored image of the face of the operator in order to produce a comparison metric, and enable activation of an ignition system of the vehicle if the comparison metric satisfies a threshold criterion.

Optionally, the safety system further comprises: a plurality of tags, each respective one of the plurality of tags being attached to a respective mobile communication device.

Optionally, the tag reader is operative to read each respective one of the plurality of tags when the respective mobile communication device is mounted to the mounting mechanism.

There is also provided according to an embodiment of the teachings of the present invention a method that comprises: coupling a tag reader to a mounting mechanism deployed within a vehicle; reading a tag, coupled to a mobile communication device, by the tag reader, in response to mounting the mobile communication device to the mounting mechanism; receiving by a control unit, a verification signal from the tag reader, in response to the reading; sending by the control unit, an activation signal to the mobile communication device, in response to the receiving the verification signal; and in response to receiving the activation signal by the mobile communication device, switching operation of the mobile communication device from a first operational mode to a second operational by disabling touchscreen operation of the mobile communication device and enabling voice command operation of the mobile communication device.

Optionally, the method further comprises: enabling activation of an ignition system of the vehicle in response to the receiving of the verification signal.

Optionally, the method further comprises: receiving by the control unit, a second verification signal from the tag reader, in response to removing the mobile communication device from the mounting mechanism; and sending by the control unit, a deactivation signal to the mobile communication device, in response to the receiving of the second verification signal.

Optionally, the method further comprises: in response to the receiving of the deactivation signal by the mobile communication device, switching operation of the mobile communication device from the second operational mode to the first operational mode by enabling touchscreen operation of the mobile communication device.

Optionally, the method further comprises: actuating an image sensor of the mobile communication device to capture an image of the face of an operator of the vehicle in response to receiving the activation signal by the mobile communication device.

Optionally, the method further comprises: comparing the captured image of the face of the operator to a stored image of the face of the operator of the vehicle in order to produce a comparison metric; and enabling activation of an ignition system of the vehicle if the comparison metric satisfies a threshold criterion.

Optionally, the method further comprises: sending a notification to a vehicle insurance provider upon each instance of switching operation of the mobile communication device from the first operational mode to the second operational mode.

There is also provided according to an embodiment of the teachings of the present invention a method that comprises: establishing a communication link between a tag and a tag reader in response to mounting of a mobile communication device to a mounting mechanism deployed within a vehicle, the tag being operatively coupled to the mobile communication device and the tag reader being operatively coupled to the mounting mechanism; receiving by a control unit, a verification signal from the tag reader, in response to establishing the communication link; sending by the control unit, an activation signal to the mobile communication device, in response to the receiving the verification signal; and in response to receiving the activation signal by the mobile communication device, switching operation of the mobile communication device from a first operational mode to a second operational by disabling touchscreen operation of the mobile communication device and enabling voice command operation of the mobile communication device.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a block diagram of components of a vehicle safety system, according to embodiments of the present disclosure;

FIG. 2 is a schematic representation of a vehicle in which components of the vehicle safety system may be deployed, according to embodiments of the present disclosure;

FIG. 3 is a schematic representation of a side view of a mounting mechanism onto which a mobile communication device can be mounted, and onto which a tag reader of the vehicle safety system may be deployed, according to embodiments of the present disclosure;

FIG. 4 is a block diagram of two mobile communication devices, each having an application executable thereon, and each having a tag that is readable by a tag reader, according to embodiments of the present disclosure;

FIG. 5 is a diagram illustrating a networked environment in which the vehicle safety system according to embodiments of the present disclosure may be operated; and

FIG. 6A-6D are flow diagrams illustrating a process for providing safety mechanisms to a vehicle, according to embodiments of the present disclosure.

### DESCRIPTION OF THE PREFERRED EMBODIMENTS

Embodiments of the present invention are directed to vehicle safety systems and methods, which, in response to mounting of a mobile communication device (e.g., smartphone) to a smartphone mounting mechanism (e.g., phone holder) deployed inside the vehicle, automatically enable the starting of the engine of the vehicle, and via an application executed on the mobile communication device, disable touchscreen operation of the mobile communication device, and enable voice command operation of the mobile communication device.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

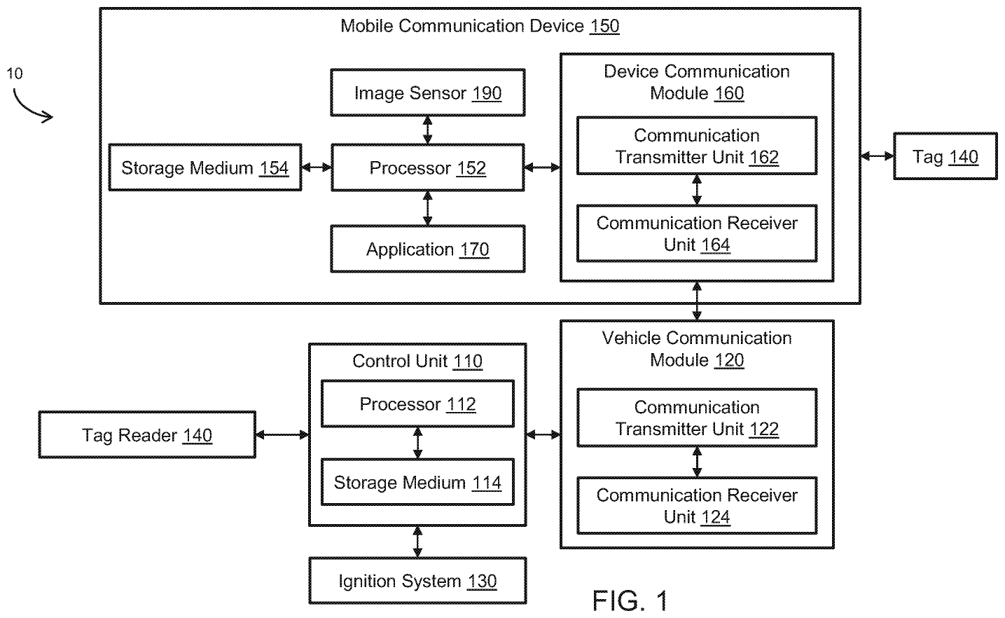

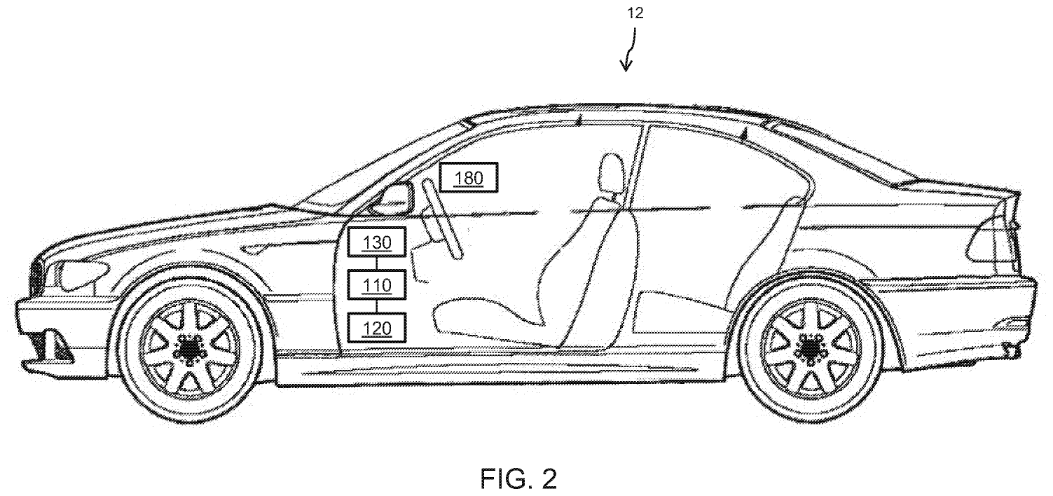

Referring now to the drawings, FIG. 1 shows a simplified block diagram of a vehicle safety system, generally designated 10, and FIG. 2 shows a schematic representation of an example deployment of certain components of the vehicle safety system 10 in a vehicle 12, according to an embodiment of the present disclosure.

Generally speaking, the vehicle safety system 10, referred to hereinafter as “ale system”, includes a tag reader 100 that is attached to a mounting mechanism 180 deployed within the vehicle 12, a tag 140 that is attached to a mobile communication device 150 (e.g., smartphone) of an operator of the vehicle 12, a control unit 110 that is electronically linked to the tag reader 100 and an ignition system 130 of the vehicle 12, a vehicle communication module 120 that is linked to the control unit 110, a device communication module 160 of the mobile communication device 150, and an application 170 that is executable on the mobile communication device 150.

Within the context of this document, the term “operator” generally refers to a person that is able to driver the vehicle 12, and may interchangeably be referred to as a “driver” or “user” of the vehicle 12.

The mobile communication device 150 initially includes conventional components, including a processing system that includes at least one computerized processor 152 coupled to a storage medium 154 such as a memory or the like. The processor 152 can be implemented as any number of computer processors, including, but not limited to, a microcontroller, a microprocessor, an ASIC, a DSP, and a state machine. Such processors include, or may be in communication with computer readable media, which stores program code or instruction sets that, when executed by the processor, cause the processor to perform actions. Types of computer readable media include, but are not limited to, electronic, optical, magnetic, or other storage or transmission devices capable of providing a processor with computer readable instructions.

It is noted that processor 152 and the storage medium 154, although shown as a single component for representative purposes, may be multiple components.

The mobile communication device 150 is mountable to the mounting mechanism 180 (i.e., the mounting mechanism 180 is configured to receive the mobile communication device 150). The mounting mechanism 180 may be generally implemented as any car phone attachment mechanism that is attachable to the dashboard area of the vehicle 12, such that the operator of the vehicle 12 can mount the mobile communication device 150 to the mounting mechanism 180 in order to allow the operator to view and operate the mobile communication device 150 while simultaneously operating the vehicle 12. Such car phone attachment mechanisms are readily available from various retailers and manufacturers, including, for example, the series of Mpow® car mounts available from Mpow® of Hong Kong.

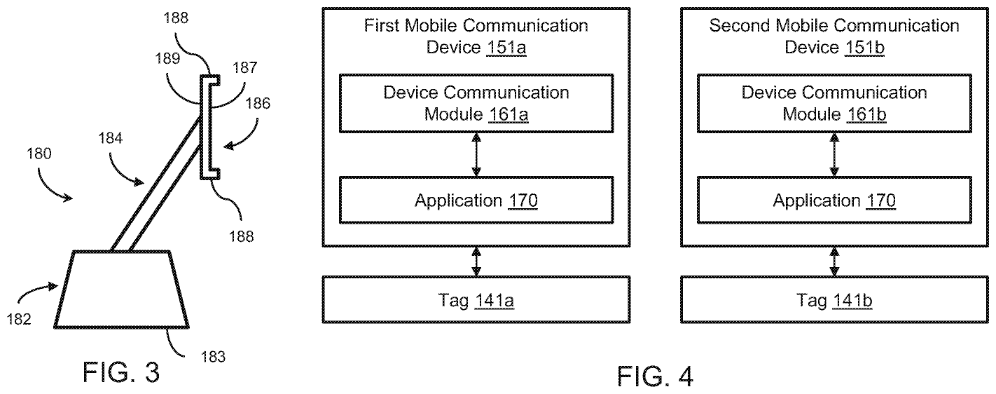

FIG. 3 illustrates a schematic representation of a non-limiting example construction of the mounting mechanism 180. In the non-limiting construction of FIG. 3, the mounting mechanism 180 includes a base member 182, an extending arm 184, and a mount member 186. The base member 182 may be implemented, for example, as a suction-type or adhesive-type attachment mechanism, that attaches to the dashboard (or dashboard area) of the vehicle 12 via suction or adhesive bonding provided at a bottom surface 183 of the base member 182. The extending arm 184 extends between the base member 182 and the mount member 186, and is attached to the base member 182 at one end and to the mount member 186 at an opposing end. The mobile communication device 150 is mountable to the mount member 186, which includes a base contact surface 187 onto which the back side of the mobile communication device 150 is placed when mounted to the mount member 186. The mount member 186 may further include clasping members 188 for engaging two or more of the peripheral edges of mobile communication device 150 in order to maintain contact between the base contact surface 187 and the back side of the mobile communication device 150.

The tag reader 100 is attached to the mount member 186, either on a portion of the base contact surface 187, or on a rear surface 189 opposing the base contact surface 187.

The tag 140 and the tag reader 100 may be implemented in various ways, According to certain embodiments, the tag 140 and the tag reader 100 are implemented as an electronic tag and an electronic tag reader, respectively, which operate according to one of various communication technologies and/or standards based on electronic tag/reader communication devices which allow such devices to establish radio communication (i.e., a radio communication link) with each other by bringing the devices within sufficient proximity of each other. Non-limiting examples of such electronic tag/reader communication devices include, but are not limited to, near field communication (NFC) tag/reader devices and radio frequency identification (RFID) tag/reader devices.

In a particularly preferred but non-limiting implementation, the tag 140 and the tag reader 100 are implemented as an NEC tag and NFC reader, respectively. Such a non-limiting implementation allows for the establishment of radio communication when the tag 140 and the tag reader 100 are brought within approximately 4 centimeters (cm) of each other. In implementations in which the tag 140 and the tag reader 100 are implemented as an NFC tag and NFC reader, respectively, the tag/reader system is preferably implemented as a passive NEC tag/reader pair. In passive NFC tag/reader pairs, the NFC reader produces (i.e., generates) and emits a carrier electromagnetic field which is modulated by the NFC tag when the tag and reader are brought into sufficient proximity of each other. The modulated carrier electromagnetic field is received by the NFC reader which enables the NFC reader to “read” the NFC tag. In addition, NFC tags in passive NFC tag/reader pairs draw power from the carrier electromagnetic field, and therefore, external power supplies (e.g., battery power) are not required in order to power the NEC tag.

In other embodiments, the tag 140 and the tag reader 100 are implemented as an optical machine-readable patterned image and an optical scanner, respectively. Non-limiting examples of optical machine-readable patterned images include barcodes, such as, for example, linear or one-dimensional barcodes, and matrix or two-dimensional barcodes (e.g., quick response codes—or QR codes). Non-limiting examples of optical scanners include bar code readers, such as, for example, laser scanners, camera-based readers, and LED scanners.

The tag 140 includes a unique identifier (e.g., a unique ID code), and is preferably attached to the back side of the mobile communication device 150, for example, via adhesively bonding the tag 140 directly to the back side of the mobile communication device 150 or to a back side of a casing of the mobile communication device 150. The tag reader 100 is preferably attached to the mount member 186 such that when the mobile communication device 150 is mounted to the mount member 186, the tag 140 and the tag reader 100 are brought into sufficient proximity of each other thereby establishing radio communication (i.e., the radio communication link) between the tag 140 and the tag reader 100. The establishment of radio communication between the tag 140 and the tag reader 100 enables the tag reader 100 to read the tag 140 and verify the unique identifier of the tag 140 against a stored existing identifier (e.g., stored unique ID code). The stored existing identifier is stored in a memory or data storage device that is linked to the tag reader 100. For example, the stored existing identifier may be stored in a memory or data storage device that is part of the control unit 110.

Upon reading the tag 140 by the tag reader 100, in response to mounting of the mobile communication device 150 to the mount member 186, the tag reader 100 extracts the unique identifier and attempts to verify the unique identifier against the stored existing identifier by, determining whether the unique identifier matches the stored existing identifier. If the tag reader 100 successfully verifies the unique identifier (i.e., if the unique identifier matches the stored existing identifier), a verification signal, indicative of the successful verification, is generated, and the tag reader 100 emits the verification signal. The verification signal is then received by the control unit 110. The verification signal is generated automatically in response to verification of the unique identifier. In certain embodiments, for example in implementations in which the tag reader 100 is implemented as an NFC tag reader, the verification signal is generated by the tag reader 100. In other embodiments, the verification signal is generated by a computerized processor that is linked (for example via a data bus) to the tag reader 100. Such computerized processors include one or more signal generating modules, which are configured to generate signals, including the verification signal.

The verification signal is sent by the tag reader 100 to the control unit 110 via signal transmission through wired or wireless communication. In embodiments in which the verification signal is transmitted via wired communication, a wired communication data link (e.g., a data bus, wire or cable) is provided between the control unit 110 and the tag reader 100 to effectuate the transmission and receipt of the verification signal. In embodiments in which the verification signal is transmitted via wireless communication, the tag reader 100 may include a wireless communication transmitter for transmitting the verification signal, and the vehicle communication module 120 may include a wireless communication receiver unit 124 configured to receive the verification signal from the tag reader 100.

Parenthetically, the tag 140 and the tag reader 100 may be brought into sufficient proximity of each other so as to establish radio communication between the tag 140 and the tag reader 100 even before the mobile communication device 150 is physically mounted to the mount member 186. For example, positioning the mobile communication device 150 adjacent to the mount member 186 may bring the tag 140 and the tag reader 100 into enough proximity of each other so as to establish radio communication between the tag 140 and the tag reader 100. As such, the tag reader 100 may read the tag 140 while the operator is in the process of mounting the mobile communication device 150 to the mount member 186, even before the mobile communication device 150 is actually mounted to the mount member 186.

Bearing this in mind, within the context of this document, the term “mounting”, as used within the context of mounting the mobile communication device 150 to the mount member 186, include actions, during the performance of which, the tag 140 and the tag reader 100 are brought into sufficient proximity of each other so as to establish radio communication between the tag 140 and the tag reader 100.

In embodiments in which the tag 140 and the tag reader 100 are implemented as an optical machine-readable patterned image and an optical scanner, respectively, the tag reader 100 may include a computerized processor that processes the information scanned by the tag reader 100 and generates the verification signal.

In response to the receipt of the verification signal from the tag reader 100, the control unit 110 automatically performs two separate actions. In the first action, the control unit 110 enables actuation of the ignition system 130 of the vehicle 12, thereby allowing the operator of the vehicle 12 to start the vehicle 12. In the second action, the control unit 110 generates and sends an activation signal to the mobile communication device 150. The activation signal is sent to the mobile communication device 150 via signal transmission through a wireless communication transmitter unit 122 of the vehicle communication module 120. The activation signal is received at the mobile communication device 150 via a wireless communication receiver unit 164 of the device communication module 160.

In certain embodiments, the device communication module 160 forwards the activation signal to the processor 152 via, for example, a data communication bus that links the device communication module 160 and the processor 152, and the processor 152 executes (i.e., launches/operates) the application 170 in response to receiving the activation signal from the device communication module 160. In other embodiments, the device communication module 160 sends an indicator signal to the processor 152 in response to receipt of the activation signal. The indicator signal may be sent to the processor 152 via, for example, a data communication bus that links the device communication module 160 and the processor 152, In such embodiments, the processor 152 executes/operates the application 170 in response to receiving the indicator signal from the device communication module 160.

If the unique identifier of the tag 140 does not match the stored existing identifier, the verification signal is not generated, and tag reader 100 does not emit the verification signal, and therefore the control unit 110 will not enable actuation of the ignition system 130, thereby not allowing the operator of the vehicle 12 to start the vehicle 12. In other words, in the case of a mismatch between the unique identifier and the stored existing identifier, there is an absence of generation and emission of the verification signal, and therefore the starting of the vehicle 12 is prevented.

Within the context of this document, the ignition system 130 generally refers to the vehicle components which control ignition of the vehicle, which in a non-limiting example includes an engine control unit or engine control module which provides electronic control to a series of actuators of the vehicle engine in order to start the engine and further control the engine after engine start. In such a non-limiting example, the control unit 110 enables actuation of the ignition system 130 by sending control signals to the engine control unit or engine control module, which in turn sends control signals to actuates the series of vehicle engine actuators.

According to certain embodiments, the vehicle communication module 120 and the device communication module 160 are implemented as communication devices that operate using variations of the IEEE 802.15 (i.e., Bluetooth®) standard. In such embodiments, the wireless communication transmitter unit 122 and the wireless communication receiver unit 164 are implemented as Bluetooth® enabled units. As is known in the art, mobile communication device 150, e.g., smartphones, commonly include Bluetooth® communication units which allow pairing of the mobile communication device 150 with other Bluetooth® enabled devices.

In response to the receipt of the activation signal from the wireless communication transmission unit 122, the mobile communication device 150 activates (i.e., launches) the application 170. The application 170, upon activation in response to receipt of the activation signal, switches operation of the mobile communication device 150 from a first operational mode to a second operational mode.

Without loss of generality, the first operational mode is equivalent to a “normal” (i.e., conventional) mode of operation of the mobile communication device 150, e.g., enabled touchscreen operation and non-voice command operation of the mobile communication device 150. In other words, in the first operational mode, the operator of the vehicle 12 can operate the mobile communication device 150 in a conventional manner that includes manual activation of a voice command interface through conventional voice activation or touchscreen operation.

To operate the mobile communication device 150 in the second operational mode, the application 170 disables touchscreen operation of the mobile communication device 150 and enables voice command operation of the mobile communication device 150. Therefore, the application 170 switches operation of the mobile communication device 150 from the first operational mode to the second operational mode, by disabling operation of the touchscreen of the mobile communication device 150 and enabling voice command operation of the mobile communication device 150.

By operating in the second operational mode, the operator of the vehicle 12 is unable to operate the mobile communication device 150 via conventional touchscreen operation, and is forced to use a voice command interface of the mobile communication device 150. The voice command interface may be an existing voice command interface, such as, for example, Ski in devices running iOS operating systems or Genie in devices running Android operating systems. Alternatively, the voice command interface may be a system specific voice command interface that is particularly adapted to operate with the system 10.

Accordingly, by mounting the mobile communication device 150 to the mount member 186, the tag reader 100 reads the tag 140 and verifies the unique identifier of the tag 140 against a stored existing identifier, and the control unit 110 automatically enables the starting of the engine of the vehicle 12 and automatically generates and sends an activation signal to the mobile communication device 150 in order to activate (i.e., launch) the application 170 to actuate the mobile communication device 150 to operate in the second operational mode.

In certain embodiments, the application 170 prompts the operator to verify/authenticate the switching of the operational mode to the second operational mode. The prompt may be an audible prompt that is output by the audio output (e.g., speakers) of the mobile communication device 150, or a written prompt displayed on the display screen of the mobile communication device 150. The operator may verify/authenticate the switching by inputting a password or passkey to the application 170 which is checked against a stored password by the application 170. The operator may input the password or passkey to the application verbally via the voice command interface or via the touchscreen function of the mobile communication device 150. In other embodiments, the switching of the operational mode of the mobile communication device 150 to the second operational mode is performed by the application 170 automatically upon activation (i.e., execution) of the application 170 in response to the receipt of the activation signal at the mobile communication device 150. Preferably, the operator may set the stored password, and may further choose whether the application 170 performs the switching automatically or via prompt, for example by changing a settings parameter of the application 170.

According to certain embodiments, upon removal (i.e., dismounting) of the mobile communication device 150 from the mount member 186, the radio communication link between the tag reader 100 and the tag 140 is disrupted. In response to removing the mobile communication device 150 from the mount member 186 and the responsive radio communication link disruption, a second verification signal, indicative of the radio communication link disruption, is generated, and the tag reader 100 emits the second verification signal. The second verification signal is then received by the control unit 110. The second verification signal is generated automatically in response to disruption of the radio communication link. In certain embodiments, for example in implementations in which the tag reader 100 is implemented as an NFC tag reader, the second verification signal is generated by, the tag reader 100. In other embodiments, the second verification signal is generated by a computerized processor that is linked to the tag reader 100. Such computerized processors include one or more signal generating modules, which are configured to generate signals, including the second verification signal. The second verification signal is sent by the tag reader 100 to the control unit 110 via signal transmission using techniques similar to as described above with reference to the verification signal.

Parenthetically, radio communication between the tag 140 and the tag reader 100 may be maintained even after the mobile communication device 150 has been removed from the mount member 186. For example, radio communication may be maintained if the mobile communication device 150, after being removed from the mount member 186, is retained at a distance from the mount member 186 that allows the tag 140 and the tag reader 100 to be within sufficient proximity of each other. Bearing this in mind, within the context of this document, the terms “removing” or “removal”, as used within the context of removal of the mobile communication device 150 from the mount member 186, include actions, during the performance of which, the tag 140 and the tag reader 100 are no longer within sufficient proximity of each other so as to maintain radio communication between the tag 140 and the tag reader 100.

In response to the receipt of the second verification signal, the control unit 110 generates and sends a deactivation signal to the mobile communication device 150. The deactivation signal is generated automatically in response to the receipt of the second verification signal, and may be sent to the mobile communication device 150 via signal transmission using techniques similar to as described above with reference to the activation signal. In response to the receipt of the deactivation signal, the application 170 actuates the mobile communication device 150 to operate in the first operational mode, i.e., the application 170 switches operation of the mobile communication device 150 from the second operational mode back to the first operational mode. As a result, the application 170 enables operation of the touchscreen of the mobile communication device 150 and disables the automatic voice command interface, such that the operator of the vehicle 12 can operate the mobile communication device 150 in a conventional manner that includes manual activation of a voice command interface through conventional voice activation or touchscreen operation.

In addition, the mobile communication device 150 may transmit an acknowledgement signal, acknowledging switching of the operation of the mobile communication device between the first and second operational modes, to the control unit 110 via the wireless transmitter unit 162 of the device communication module 160.

The control unit 110 is an electronic control unit that preferably includes at least one processor 112 coupled to a storage medium 114 such as a memory or the like. The processor 112 can be implemented as any number of computer processors, including, but not limited to, a microcontroller, a microprocessor, an ASIC, a DSP, and a state machine. Such processors include, or may be in communication with computer readable media, which stores program code or instruction sets that, when executed by the processor, cause the processor to perform actions. Types of computer readable media include, but are not limited to, electronic, optical, magnetic, or other storage or transmission devices capable of providing a processor with computer readable instructions. In general, the storage medium 114 may be configured to store the stored existing identifier in order to verify the unique identifier of the tag 140.

It is noted that processor 112 and the storage medium 114, although shown as a single component for representative purposes, may be multiple components. The processor 112 includes one or more signal generating modules, which are configured to generate signals, including the activation and deactivation signals discussed above.

The control unit 110 may be implemented as part of the engine control unit (or engine control module) or on-hoard diagnostics computer systems of the vehicle 12. The control unit 110 may be used as supplementary vehicle security mechanism to existing vehicle security mechanisms. According to certain embodiments, the control unit 110 is implemented as part of a vehicle code control system that conventionally enables the operator of the vehicle 12 to start the vehicle 12 only in response to entry and verification of a key code. Such vehicle code control systems may be colloquially referred to as “immobilizer systems”, which require the operator of the vehicle to input the correct unique code, via a keypad in the vehicle 12, in order to be able to start the vehicle 12. The vehicle code control system is linked to the ignition system 130, whereby input of the correct code actuates the ignition system 130 to allow starting of the vehicle, and input of the incorrect code (or lack of code input) actuates the ignition system 130 to prevent starting of the vehicle 12. In such embodiments, the system 10 provides an additional vehicle security layer by requiring the operator of the vehicle to input the correct unique code and mount the mobile communication device 150 to the mounting mechanism. In this way, an unauthorized operator is prohibited from operating (i.e., starting) the vehicle 12 if either: i) the incorrect unique code, or no code, is input to the keypad, or ii) the mobile communication device 150 with the correct tag 140 is not mounted to the mount member 186.

In other embodiments, the vehicle 12 lacks any immobilizer system, and the control unit 110 provides a single layer of vehicle security. In this way, an unauthorized operator is prohibited from operating (i.e., starting) the vehicle 12 only if the mobile communication device 150 with the correct tag 140 is not mounted to the mount member 186.

Although the embodiments described thus far have pertained to a tag reader that is operative read and verify a single tag that is attached to a single mobile communication device, other embodiments are possible in which the tag reader is operative to read and verify multiple tags, wherein each tag is attached to a respective mobile communication device. In such embodiments, the system 10 allows multiple operators/users to operate the vehicle 12 by providing each operator with a tag that includes a unique identifier. Such embodiments may be applicable in situations in which a single vehicle is used by multiple operators, for example, a husband and wife that share a single vehicle.

FIG. 4 illustrates a block diagram of a non-limiting example in which two respective mobile communication devices and tags are used, according to the above described embodiments. In such a non-limiting example, a first mobile communication device 151a, which has a first tag 141a attached thereto, is operable by a first operator, and a second mobile communication 151b, which has a second tag 141b attached thereto, is operable by a second operator.

Instantiations of the application 170 are separately executable on each of the mobile communication devices 151a and 151b. Furthermore, the first mobile communication device 151a has a first device communication module 161a, and the second mobile communication device 151b has a second device communication module 161b.

The structure and operation of the mobile communication devices 151a and 151b is generally similar to the structure and operation of the mobile communication device 150, and should be understood by analogy thereto. Likewise, the structure and operation of the tags 141a and 141b is generally similar to the structure and operation of the tag 140, and should be understood by analogy thereto. Moreover, the structure and operation of the device communication modules 161a and 161b is generally similar to the structure and operation of the device communication module 160, and should be understood by analogy thereto.

A collection of existing unique identifiers is stored, for example, in the storage medium 114. Upon mounting of one of the mobile communication devices 151a and 151b to the mount member 186, the tag reader 100 reads the relevant tag (e.g., the first tag 141a or the second tag 141b) and attempts to verify the unique identifier of the relevant tag against the stored existing identifiers. The remaining processes related to verification of the unique identifier and execution of the application 170 are similar to as described above with reference to the single mobile communication device 150.

Note that the above description of a single tag reader operative to read and verify two tags which are attached to two respective mobile communication devices is for example purposes only, and the concept of using a single tag reader that is operative to read and verify multiple tags deployed on respective mobile communication devices can be generalized to cases of more than two tags.

According to certain embodiments, the system 10 utilizes an image sensor 190 (i.e., camera) of the mobile communication device 150 in order to perform facial recognition techniques to provide an added layer of security. In such embodiments, the application 170 actuates the image sensor 190 to perform actions in response to the receipt of the activation signal from the wireless communication transmission unit 122. The actuation of the image sensor 190 by the application 170 is preferably in addition to the switching, by the application 170, of the operation of the mobile communication device 150 from the first operational mode to the second operational mode. The actions performed by the image sensor 190 in response to actuation by the application 170 include capturing one or more images of a scene within the field of view of the image sensor 190. Since the application 170 is activated in response to mounting of the mobile communication device 150 to the mount member 186 by the operator, the field of view of the scene captured by the image sensor 190 includes the space surrounding the driver's seat of the vehicle 12, which during operation includes the face of the operator.

The application 170 may compare the one or more images captured by the image sensor 190 against a baseline image of the face of the operator in order to make a determination as to whether the face in the images captured by the image sensor 190 matches the face in the baseline image. The baseline image may be stored in a memory, such as the storage medium 154 of the mobile communication device 150, or in the storage medium 114 of the control unit 110. The application 170 actuates a computerized processor, such as the processor 152 of the mobile communication device 150 or the processor 112 of the control unit 110, to extract landmark features (e.g., the nose, eyes, cheekbones, lips, etc.) from the baseline image. The application 170 then actuates the computerized processor to analyze the shape, position and size of the extracted facial features.

In operation, the application 170 makes the determination of a facial match by first comparing the captured images to the baseline image to produce a comparison metric, and then evaluating the comparison metric against a threshold. The application 170 may perform the image comparison by actuating the computerized processor to extract landmark features from the images captured by the image sensor 190, and then comparing the landmark features extracted from the images captured by the image sensor 190 with those extracted from the baseline image. The comparison yields a comparison metric, which may be, for example, a fidelity score indicative of the closeness of a match. For example, a higher fidelity score corresponds to a higher likelihood of a facial match. The application 170 may then actuate the computerized processor to evaluate the comparison metric against a threshold criterion. For example, fidelity scores above a threshold value return a positive indication of a facial match, whereas fidelity, scores below a threshold value return an indication of a facial mismatch.

In response to a positive indication of a facial match, the application 170 actuates the control unit 110 to enable actuation of the ignition system 130 of the vehicle 12, thereby allowing the operator of the vehicle 12 to start the vehicle 12. In response to an indication of a facial mismatch, the application 170 actuates the control unit 110 to prevent starting of the vehicle by the ignition system 130. The prevention of vehicle start is effectuated by actuating the ignition system 130 to prevent starting of the vehicle 12.

The application 170 may be implemented as a plurality of software instructions, or computer readable program code, executed by the processor 152 of the mobile communication device 150. The application 170 may be developed using various mobile application programming development languages, including, but not limited to, Python, Java, PHP, JavaScript, Ruby, Perl, C #, and objective C.

According to certain embodiments, the user (i.e., operator) may be required to initially register with a service provider via a computerized server in order to download and install the application 170 on the mobile communication device 150, and install the various physical components of the system 10. In response to registration, the user may be provided with the aforementioned physical components, as well as information and instructions for installing the aforementioned components and the application 170.

In a non-limiting sequence of processes to install the application 170, the user may initially register via a web site that is hosted by the computerized server, and that is accessible through one or more web servers over a network. The user may be requested to provide vehicle information, such as the license plate number, vehicle identification number, vehicle make, and vehicle model, as well as personal information, such as name, address, sex, driver's license number, mobile phone number, national identification number, date of birth, vehicle insurance provider, and vehicle insurance policy number.

In response to registration, the service provider may provide the user with a link to download the application 170 from an on-line store that is accessible over the network, such as, for example, the Google Play Store from Google of Mountain View, Calif., or the iTunes Store from Apple of Cupertino, Calif.

In other embodiments, the user (i.e., operator) may download the application 170 from the on-line store, and perform registration processes, including provision of vehicle information and personal information to the service provider through the application 170.

Once the application 170 is installed on the mobile communication device 150, the application 170 may be executed (i.e., launched) by the processor 152, and may prompt the user to input an authentication code (e.g., a one-time password). The authentication code may be input via the touchscreen function of the mobile communication device 150, and is preferably provided to the user by the service provider, for example via short message service text messaging received at the mobile communication device 150. The user may then input the received authentication code via the application 170, in response to the prompt, and the application 170 may then authenticate the user in response to the input authentication code.

Subsequent to authentication, the application 170 may prompt the user to capture a facial image himself while in the driving position (i.e., seated in the driver's seat of the vehicle 12). The prompt may be a written prompt displayed via the display screen of the mobile communication device 150, or may be an audible prompt that is output by the audio output (e.g., speakers) of the mobile communication device 150. The image is captured using the image sensor 190 of the mobile communication device 150. The application 170 may then display a “home” screen that includes the image of the user, as well as various personal user details (e.g., date of birth, driver's license number, etc.) and vehicle details (vehicle license plate number, etc.).

The facial image of the user captured in response to the prompting by the application 170 may be used as the baseline image of the face of the operator, which is used by the application 170 in order to make a determination of a facial match, as previously discussed.

As mentioned above, the user may be provided with physical components of the system 10 subsequent to registration, as well as information and instructions for installing the aforementioned components. The user may install (i.e., deploy) the tag 140 on the back portion of the mobile communication device 150 by adhesively bonding the tag 140 to the mobile communication device 150. The user may also install (i.e., deploy) the tag reader 100 by adhesively bonding the tag reader 100 to a portion of the base contact surface 187, or a portion of the rear surface 189.

In operation, and specifically when operating in the second operational mode, the application 170 provides interface functionality to allow the operator to use various features of the mobile communication device 150 using only voice commands. The features of the mobile communication device 150 that are usable while operating in the second operational mode include navigation applications, text messaging applications (e.g., WhatsApp), electronic mail (i.e., email) applications, phone services, and reminder services and applications.

For example, the operator may provide voice commands by audibly dictating one of several keywords in order to allow the operator to utilize various features of the mobile communication device 150. The keywords may be selected by the operator upon installation of the application 170 or may be pre-programmed into the application 170 during development of the application 170. Examples of keywords include, but are not limited to, “navigation”, “make phone call”, “answer phone call”, “read text message”, “compose text message”, “read email”, and “compose email”.

In response to receipt of voice commands, e.g., keywords, the application 170 converts the received voice commands into machine readable instructions which can be read by the processor 152. The machine-readable instructions can be used by the processor 152 to allow the application 170 to analyze the voice commands to perform responsive actions, and to interact with other mobile software applications and services installed on the mobile communication device 150, including, for example, navigation applications, text messaging applications (e.g., WhatsApp), electronic mail (i.e., email) applications, phone services, and reminder services and applications. The interaction between the application 170 and the other software applications is enabled by sharing data between the various interacting applications via a content provider to allow the applications to expose data and database to each other through queries of the content provider. The data sharing allows the application 170 to transfer intents to, and receive intents from, the other mobile software applications with which the application 170 can interact.

Each keyword may trigger a series of actions by the application 170. The actions may include a series of audible questions or prompts that are output by the audio output (e.g., speakers) of the mobile communication device 150. For example, in response to the keyword “navigation”, the application 170 may prompt the operator to provide a geographic location or destination. The operator may then audibly dictate a location or destination, after which the application 170 may execute navigation functionality, by, for example, executing a separate navigation application such as Waze or Google Maps.

As a further example, in response to the keywords “answer phone call” during an incoming phone call, the application 170 may answer the phone call. In response to the keywords “make phone call”, the application 170 may request the phone number of the phone call recipient, or may prompt the operator to indicate whether the phone call recipient is in a stored contact list in the mobile communication device 150.

As a further example, in response to the keywords “read text message” upon receipt of an incoming text message, the application 170 may audibly dictate a received text message to the operator. Similarly, in response to the keywords “compose text message”, the application 170 may request the phone number of a text message recipient, or may prompt the operator to indicate whether the text message recipient is in a stored contact list in the mobile communication device 150. The application 170 may then also prompt the operator to audibly dictate the text message. The application 170 may also prompt the operator to indicate the text messaging service through which the text message is to be sent. In response, the application 170 may execute the indicated text messaging service application, for example, WhatsApp, in order to send the message. In certain embodiments, the application 170 provides the dictated message as a voice message. In other embodiments, the application 170 utilizes voice to text functionality in order to provide the message as a text message.

As a further example, in response to the keywords “read email” upon receipt of an incoming email, the application 170 may audibly dictate a received email to the operator. Similarly, in response to the keywords “compose email”, the application 170 may request the email address of an email recipient, or may prompt the operator to indicate whether the email recipient is in a stored contact list in the mobile communication device 150. The application 170 may then prompt the operator to audibly dictate the email message. The application 170 may then utilize voice to text functionality in order to provide the email message as text to the email application.

Note that the above examples of keywords and actions performed by the application 170 constitute an example set of keywords and actions used for the purposes of better explaining the operation of the application 170. The operator may change the sets of keywords and their related prompts and functionalities via settings options of the application 170. As should be apparent to one of skill in the art, various other keywords may be utilized, and various other actions may be performed by the application 170 in response to such keywords.

As mentioned above, the user may be prompted to provide vehicle insurance related information upon initial registration and installation of the application 170. According to certain embodiments, the vehicle insurance provider may provide a monetary incentive, for example in the form of an insurance premium discount, to users to install and utilize the system 10.

In such embodiments, information pertaining to the switching of the mobile communication device 150 between the first and second operational modes is shared with the insurance provider. The following paragraphs describe such information sharing embodiments.

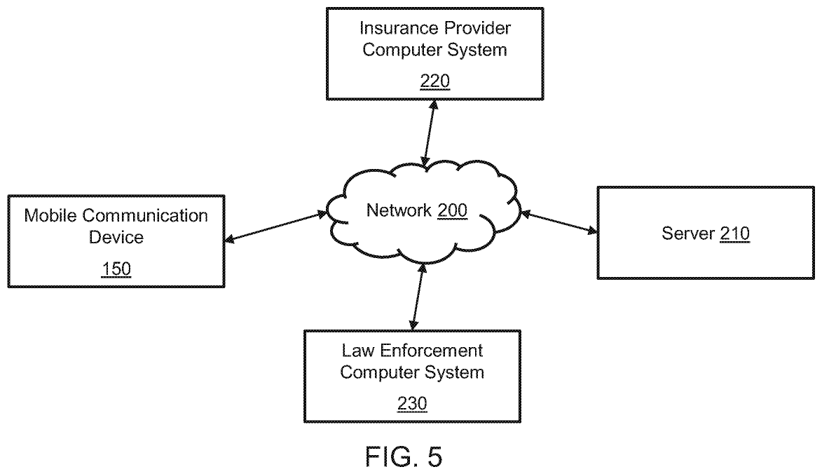

With continued reference to FIGS. 1-4, refer now to FIG. 5, an illustrative example environment in which such information sharing embodiments are performed over a network 200. The mobile communication device 150 is linked to the network 200. The network 200 may be formed of one or more wireless or wired networks, including, for example, cellular networks, the Internet, wide area, public, and local networks. Also linked to the network 200 is a server 210, which may be formed as one or more computerized servers or server systems. The server 210 may include the server that hosts registration web site, discussed above. As such, the service provider of the system 10 may operate the server 210.

The server 210 stores user information, in the form of data, that is provided by the application 170 via the mobile communication device 150. The user information includes, for example, information related to the switching between the first and second operational modes. For example, upon each instance of actuation of the mobile communication device 150 to switch operation to the second operational mode, the application 170 actuates the mobile communication device 150 to transmit an activation message to the server 210. The activation message includes information indicative of the activation of the mobile communication device 150 to switch operation to the second operational mode. Alternatively, the activation message may be stored within the storage medium 154 of the mobile communication device 150, which is accessible by the application 170, or within the storage medium 114 of the control unit 110.

Similarly, upon each actuation of the mobile communication device 150 to switch operation from the second operational mode to the first operational mode, the application 170 actuates the mobile communication device 150 to transmit a deactivation message to the server 210. The deactivation message includes information indicative of the mobile communication device 150 returning to operate in the first operational mode. Alternatively, the deactivation message may be stored within the storage medium 154 of the mobile communication device 150, which is accessible by the application 170, or within the storage medium 114 of the control unit 110

An insurance provider computer system 220 is also linked to the network 210, and is provided with access to the server 210. The activation and deactivation messages are logged (i.e., stored) on the server 210 and can be accessed by the computer system 220. Access to the activation messages can be used by the insurance provider to verify, in the case of an accident or traffic violation, whether the application 170 actuated the mobile communication device 150 to switch operation of the mobile communication device 150 from the first operational mode to second operational mode.

A law enforcement computer system 230 may also be linked to the network 210, and may be provided with access to the server 210. Access to the deactivation messages can be used by the insurance provider and a law enforcement agency (e.g., police) to identify vehicle theft events.

It is noted herein that the aforementioned links to the network 200 are enabled by appropriate network interfaces deployed on the mobile communication device 150, the insurance provider computer system 220, and the law enforcement computer system 230.

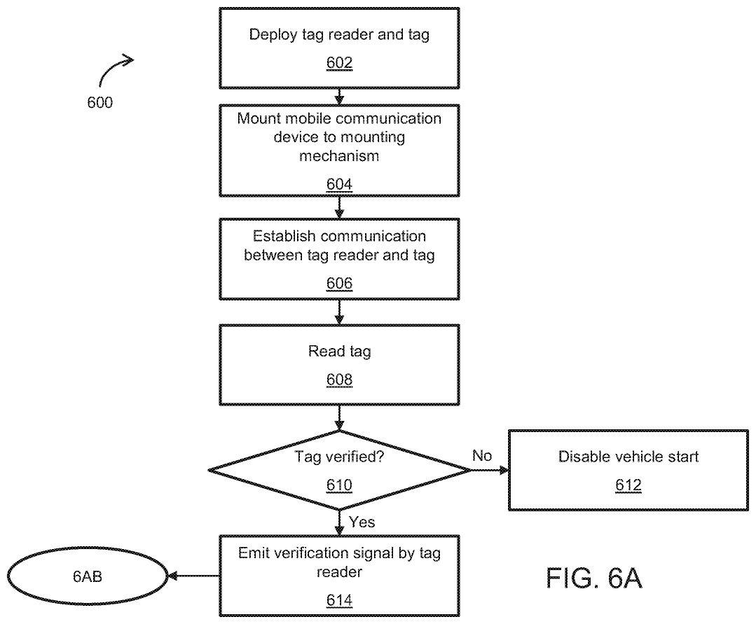

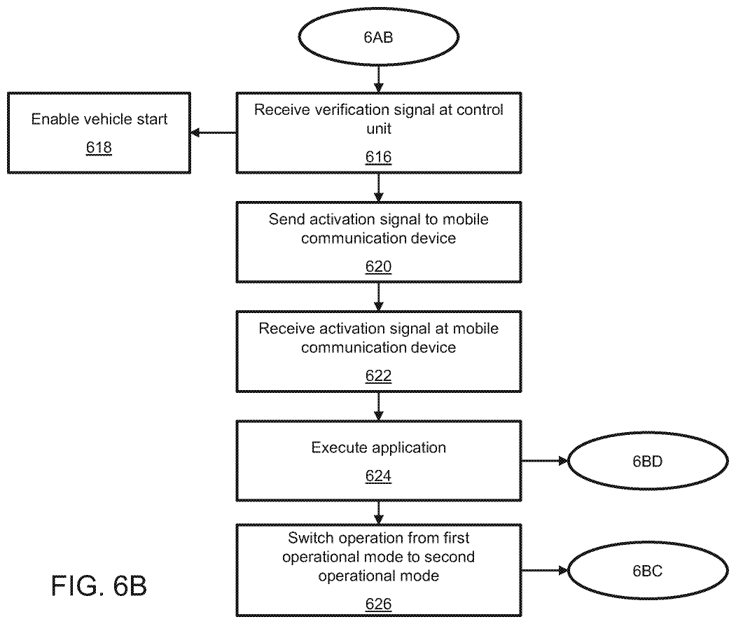

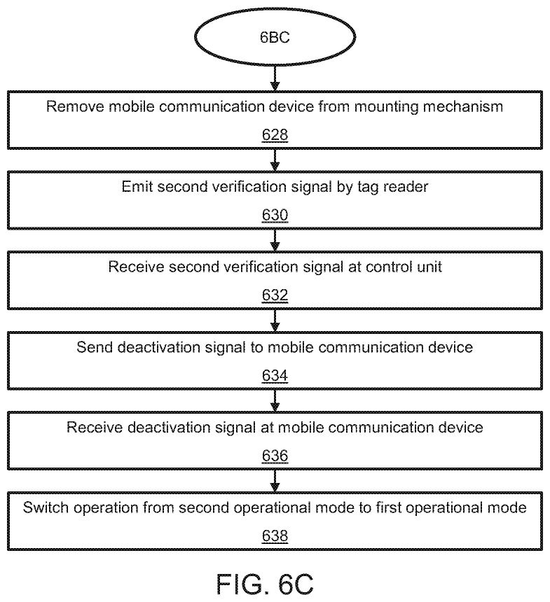

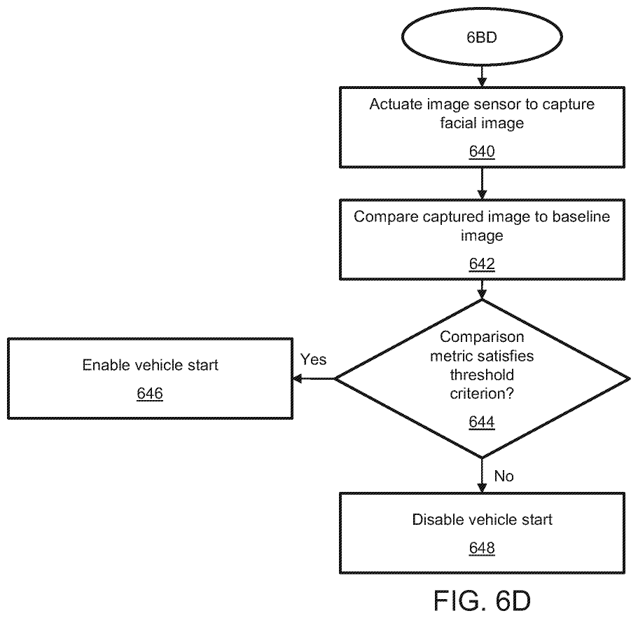

Attention is now directed to FIGS. 6A-6D, which show a flow diagram detailing a process 600 in accordance with embodiments of the disclosed subject matter. Reference is also made to the elements shown in FIGS. 1-4. The process 600 includes method steps for providing safety mechanisms to a vehicle. Some of the sub-processes of the process 600 may be performed manually, while other sub-processes may be performed automatically. The sub-processes of the process 600 can be performed in real-time.

The process 600 begins at block 602, where the tag reader 100 and the tag 140 are deployed. The deployment of the tag reader 100 entails attaching the tag reader 100 to the mount member 186, and the deployment of the tag 140 entails attaching the tag 140 to the back side of the mobile communication device 150. As discussed above, the attachment of the tag reader 100 and the tag 140 may be performed by the operator of the vehicle 12 using adhesive bonding techniques.

The process 600 then moves to block 604, where the operator of the vehicle 12 mounts the mobile communication device 150 to the mount member 186. As a result of the mounting, the tag 140 and the tag reader 100 are brought into proximity with each other. The process 600 then moves to block 606, where communication is established between the tag 140 and the tag reader 100 as a result of the proximity between the tag 140 and the tag reader 100.

Once communication is established, the process 600 moves to block 608, the tag reader 100 reads the tag 140. The process 600 then moves to block 610 where the tag reader 100 attempts to verify the unique identifier of the tag 140 against a stored existing identifier (or identifiers). If the tag reader 100 is unable to verify the tag 140 against the stored existing identifier, the process 600 moves from block 610 to block 612, where the control unit 110 prevents starting of the vehicle 12. As discussed above, the prevention of vehicle start is accomplished by not enabling actuation of the ignition system 130.

If the tag reader 100 is able to verify the tag 140 against the stored existing identifier, the process 600 moves from block 610 to block 614, where a verification signal is generated, and the tag reader 100 emits the generated verification signal in response to the reading and verification performed in blocks 608 and 610.

The process 600 then moves to block 616, where the verification signal is received at the control unit 110. In response to receiving the verification signal, the process 600 moves to block 618, where the control unit 110 enables starting of the vehicle by enabling actuation of the ignition system 130. As a result, starting of the engine of the vehicle 12 is enabled only upon receipt of the verification signal by the control unit 110. In parallel to block 618, the process 600 also executes block 620, where the control unit 110 generates and sends an activation signal to the mobile communication device 150 in order to execute the application 170.

From block 620, the process 600 moves to block 622, where the mobile communication device 150 receives the activation signal sent by the control unit 110. The process 600 then moves to block 624, where the application 170 is executed in response to the receipt of the activation signal.

The process 600 then moves to block 626, where the application 170 switches operation of the mobile communication device 150 from the first operational mode to the second operational mode (i.e., actuates the mobile communication device 150 to operate in the second operational mode). As discussed above, operation in the second operational mode entails the application 170 disabling operation of the touchscreen of the mobile communication device 150 and enabling voice command operation of the mobile communication device 150.

From block 626, the process 600 may then move to block 628, where the mobile communication device 150 is removed from the mounting mechanism 180. In response to the removal of the mobile communication device 150, the communication link established between the tag 140 and the tag reader 100 in block 606 is disrupted. The process 600 then moves to block 630, where in response to the disruption of the communication link, a second verification signal is generated, and the tag reader 100 emits the second verification signal.

The process 600 then moves to block 632, where the second verification signal is received at the control unit 110. In response to receiving the second verification signal, the process 600 moves to block 634, where the control unit 110 generates and sends a deactivation signal to the mobile communication device 150. From block 634, the process 600 moves to block 636, where the mobile communication device 150 receives the deactivation signal sent by the control unit 110.

The process 600 then moves to block 638, where in response to the receipt of the deactivation signal, the application 170 switches operation of the mobile communication device 150 from the second operational mode back to the first operational mode.

Returning to block 624, the process 600 may also optionally move to block 640, where the application 170 actuates the image sensor 190 to capture one or more images of the face of the operator of the vehicle 12. From block 640, the process 600 may then move to block 642, where the application 170 actuates a computerized processor to compare the captured images against a baseline image of the face of the operator to produce a comparison metric. The baseline image may be captured by the image sensor 190 during initial installation of the application or deployment of the tag reader 100 and the tag 140 (as in block 602). The process 600 may then move to block 644, where the application 170 actuates the computerized processor to evaluate the comparison metric against a threshold criterion.

If the comparison metric satisfies the threshold criterion, the process 600 moves form block 644 to block 646, where the application 170 actuates the control unit 110 to enable starting of the vehicle by enabling actuation of the ignition system 130. If the comparison metric fails to satisfy the threshold criterion, the process 600 moves from block 644 to block 648, where the application 170 actuates the control unit 110 to disable actuation of the ignition system 130, thereby preventing the operator from starting the vehicle 12.

Although the embodiments described thus far have pertained to a system in which communication is established by bringing a tag and a tag reader into proximity with each other, other embodiments are possible in which other wireless communication protocols are used to establish a radio communication link between two communication devices. In such embodiments, the vehicle communication module 120 and the device communication module 160 may be configured as Bluetooth® transceivers, which enables the establishment of a radio communication link between the communication modules 120 and 160 (i.e., pairing of the mobile communication device 150 with the vehicle communication module 120) when the mobile communication device 150 is brought into close enough proximity of the vehicle communication module 120 in order to be within Bluetooth® range. As is known in the art, Bluetooth® range is typically up to 30 meters for class 1 devices, and is most commonly, between 0.5 meters and 10 meters for class 2-4 devices, with class 3 devices having an average range of 1 meter.

In such embodiments, a unique identifier of the mobile communication device 150 is embedded in the transmitted wireless communication signals that are received by the vehicle communication module 120. The vehicle communication module 120 and the control unit 110 together perform the functionality of the tag reader 100 described in previous embodiments. Specifically, the vehicle communication module 120 receives the unique identifier from the device communication module 160, and the control unit 110 attempts to verify the unique identifier against a stored existing identifier (similar to as executed in block 610 of FIG. 6A). If the control unit 110 successfully verifies the unique identifier, the control unit 110 actuates the vehicle communication module 120 to transmit the activation signal (similar to as executed in block 620 of FIG. 6B).

Implementation of the system and/or method of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. As discussed above, the data management application may be implemented as a plurality of software instructions or computer readable program code executed on one or more processors of a mobile communication device. As such, in an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The block diagrams in the drawings illustrate the architecture, functionality, and operation of possible implementations of systems, devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A safety system for a vehicle, comprising:
a tag reader operatively coupled to a mounting mechanism deployed within a vehicle, and the tag reader operative to read a tag in communication with a mobile communication device in response to mounting the mobile communication device to the mounting mechanism;
a control unit configured to:
receive a verification signal from the tag reader in response to reading of the tag by the tag reader, and
send an activation signal to the mobile communication device in response to receipt of the verification signal; and
an application executable on the mobile communication device, the application configured to:
switch operation of the mobile communication device from a first operational mode to a second operational mode by disabling touchscreen operation of the mobile communication device and enabling voice command operation of the mobile communication device in response to receipt of the activation signal by the mobile communication device.

2. The safety system of claim 1, wherein the control unit is further configured to enable activation of an ignition system of the vehicle in response receipt of the verification signal.

3. The safety system of claim 1, wherein the tag is implemented as an electronic tag, and wherein the tag reader is implemented as an electronic tag reader.

4. The safety system of claim 1, wherein the tag is implemented as a near field communication (NFC) tag.

5. The safety system of claim 1, wherein the tag reader is implemented as a near field communication (NFC) reader.

6. The safety system of claim 1, wherein the tag is implemented as a barcode, and wherein the tag reader is implemented as a bar code reader.

7. The safety system of claim 1, wherein the control unit is further configured to:
receive a second verification signal from the tag reader in response to removing the mobile communication device from the mounting mechanism, and
send a deactivation signal to the mobile communication device in response receipt of the second verification signal.

8. The safety system of claim 7, wherein the application is further configured to:
switch operation of the mobile communication device from the second operational mode to the first operational mode by enabling touchscreen operation of the mobile communication device in response to receipt of the deactivation signal by the mobile communication device.

9. The safety system of claim 1, further comprising:
a communication transmission unit operatively coupled to the control unit, and wherein the control unit is configured to send the activation signal to the mobile communication device via transmission of the activation signal by the communication transmission unit.

10. The safety system of claim 9, wherein the communication transmission unit is implemented as a wireless communication transmission unit.

11. The safety system of claim 9, wherein the communication transmission unit is implemented as a Bluetooth communication transmission unit.

12. The safety system of claim 1, wherein the application is further configured to: actuate an image sensor of the mobile communication device to capture an image of the face of an operator of the vehicle in response to receipt of the activation signal by the mobile communication device.

13. The safety system of claim 11, wherein the application is further configured to:
compare the captured image of the face of the operator to a stored image of the face of the operator in order to produce a comparison metric, and
enable activation of an ignition system of the vehicle if the comparison metric satisfies a threshold criterion.

14. The safety system of claim 1, further comprising: a plurality of tags, each respective one of the plurality of tags being attached to a respective mobile communication device.

15. The safety system of claim 14, wherein the tag reader is operative to read each respective one of the plurality of tags when the respective mobile communication device is mounted to the mounting mechanism.

16. A method, comprising:
coupling a tag reader to a mounting mechanism deployed within a vehicle;
reading a tag, coupled to a mobile communication device, by the tag reader, in response to mounting the mobile communication device to the mounting mechanism;
receiving by a control unit, a verification signal from the tag reader, in response to the reading;
sending by the control unit, an activation signal to the mobile communication device, in response to the receiving the verification signal; and
in response to receiving the activation signal by the mobile communication device, switching operation of the mobile communication device from a first operational mode to a second operational by disabling touchscreen operation of the mobile communication device and enabling voice command operation of the mobile communication device.

17. The method of claim 16, further comprising:
enabling activation of an ignition system of the vehicle in response to the receiving of the verification signal.

18. The method of claim 16, further comprising:
receiving by the control unit, a second verification signal from the tag reader, in response to removing the mobile communication device from the mounting mechanism; and
sending by the control unit, a deactivation signal to the mobile communication device, in response to the receiving of the second verification signal.

19. The method of claim 18, further comprising:
in response to the receiving of the deactivation signal by the mobile communication device, switching operation of the mobile communication device from the second operational mode to the first operational mode by enabling touchscreen operation of the mobile communication device.

20. The method of claim 16, further comprising:
actuating an image sensor of the mobile communication device to capture an image of the face of an operator of the vehicle in response to receiving the activation signal by the mobile communication device.

21. The method of claim 20, further comprising:
comparing the captured image of the face of the operator to a stored image of the face of the operator of the vehicle in order to produce a comparison metric; and
enabling activation of an ignition system of the vehicle if the comparison metric satisfies a threshold criterion.

22. The method of claim 16, further comprising:
sending a notification to a vehicle insurance provider upon each instance of switching operation of the mobile communication device from the first operational mode to the second operational mode.

23. A method, comprising:
establishing a communication link between a tag and a tag reader in response to L ounting of a mobile communication device to a mounting mechanism deployed within a vehicle, wherein the tag is operatively coupled to the mobile communication device and the tag reader is operatively coupled to the mounting mechanism;
receiving by a control unit, a verification signal from the tag reader, in response to establishing the communication link;
sending by the control unit, an activation signal to the mobile communication device, in response to the receiving the verification signal; and
in response to receiving the activation signal by the mobile communication device, switching operation of the mobile communication device from a first operational mode to a second operational by disabling touchscreen operation of the mobile communication device and enabling voice command operation of the mobile communication device.
